(19) United States
(12) Patent Application Publication
(10) Pub. No.: US 2012/0299868 A1
(43) Pub. Date: Nov. 29, 2012

(54) High Noise Immunity and High Spatial Resolution Mutual Capacitive Touch Panel

(75) Inventors: Milind Bhagavat, Fremont, CA (US); David Sobel, Los Altos, CA (US); John Walley, Ladera Ranch, CA (US); Sumant Ranganathan, Saratoga, CA (US)

(73) Assignee: BROADCOM CORPORATION, IRVINE, CA (US)

(21) Appl. No.: 13/331,337

(22) Filed: Dec. 20, 2011

Related U.S. Application Data
(60) Provisional application No. 61/489,992, filed on May 25, 2011.

(51) Int. Cl. G06F 3/044

(52) U.S. Cl. 345/174

(57) ABSTRACT

A mutual capacitive touch panel providing improved noise immunity and improved spatial resolution is described. The touch panel includes a drive line having a plurality of drive electrodes. The touch panel further includes a sense line arranged at an angle with respect to the drive line and the sense line having a plurality of sense electrodes, such that each of the plurality of sense electrodes overlies one of the plurality of drive electrodes. The touch panel is further configured such that a perimeter of each of the plurality of drive electrodes encompasses a perimeter of at least one of the plurality of sense electrodes.

This application is based on and claims priority from U.S. Provisional Patent Application Ser. No. 61/489,992, filed on May 25, 2011, which is hereby incorporated by reference in its entirety.

### BACKGROUND

Conventional designs for mutual capacitive touch panels, also called self-capacitive touch panels, have typically been bulky, susceptible to electromagnetic interference, and relatively insensitive to fine-pitch touches. Mitigating one or more of these aforementioned disadvantages of the conventional designs may require undesirable cost increases. Moreover, because of typical low noise immunity, conventional designs require a touch panel to be spaced a minimum distance from an underlying display in order to avoid suffering detrimental effects due to electromagnetic noise. Further, increasing the thickness of conventional touch panels, bottom, middle and cover glass films are also typically used to insulate the sense and drive electrodes from one another and from direct external contact.

Further, as technology advances, touch panel applications require higher and higher spatial resolution capabilities. While conventional patterns of sense and drive conductors may be decreased in size to correspondingly increase spatial resolution, doing so increases the number of panel input/output (I/O) connections required to accommodate the corresponding increased number of sense and drive electrodes. However, an increased number of panel I/O connections undesirably increases the complexity and cost of both the touch panel and the touch sensor controller.

### SUMMARY

The present disclosure is directed to a mutual capacitive touch panel providing improved noise immunity and improved spatial resolution, substantially as shown in and/or described in connection with at least one of the figures, as set forth more completely in the claims.

### BRIEF DESCRIPTION OF THE DRAWINGS

FIG. 1 presents a perspective and exploded view of a conventional mutual capacitive touch panel display;

FIG. 2 presents a diagram showing the operation of a conventional array sensing circuit configured to sense a finger touch;

FIG. 3A presents a top view of an array of drive and sense electrodes of a conventional mutual capacitive touch panel display;

FIG. 3B presents a cross-sectional view of an array of drive and sense electrodes of a conventional mutual capacitive touch panel display as in FIG. 3A;

FIG. 4A presents a top view of a bridging type stack-up array of drive and sense electrodes used by a conventional mutual capacitive touch panel display;

FIG. 4B presents a cross-sectional view of a bridging type stack-up array of drive and sense electrodes used by a conventional mutual capacitive touch panel display as in FIG. 4A;

FIG. 5A presents an exemplary top view of drive electrode and sense electrode arrays of a mutual capacitive touch panel display, according to one implementation of the present application;

FIG. 5B presents an exemplary cross-sectional view of the drive electrode and sense electrode arrays of the mutual capacitive touch panel display shown in FIG. 5A, according to one implementation of the present application;

FIGS. 5C and 5D present exemplary cross-sectional views of electromagnetic field lines of sense and drive electrodes within a mutual capacitive touch panel display, according to one implementation of the present application;

FIGS. 6A-6D present exemplary top views of sense and drive electrode patterns offering various spatial resolutions and noise immunities within a mutual capacitive touch panel display, according to one implementation of the present application;

FIGS. 7A-7C present exemplary top views of sense and drive electrode patterns offering high noise immunity while increasing overall spatial resolutions within a mutual capacitive touch panel display, according to one implementation of the present application;

FIG. 8 presents an exemplary top view of an interdigitated sense and drive electrode pattern requiring low control system complexity within a mutual capacitive touch panel display, according to one implementation of the present application;

FIG. 9 presents an exemplary flowchart illustrating a method for providing improved noise immunity and spatial resolution in a touch panel display, according to one implementation of the present application.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As explained above, conventional approaches to designing mutual capacitive touch panels, also called self-capacitive touch panels, have resulted in touch panels that are bulky, susceptible to electromagnetic interference, and insensitive to fine-pitch touches. Various implementations of the present application provide mutual capacitive touch panels that cost effectively address electromagnetic noise immunity from an underlying display such as an LCD, for instance, fine pitch conductive stylus support, touch sensing sensitivity, and overall thinner touch panels.

FIG. 1 presents a perspective view of a conventional mutual capacitive touch panel display, exploded. Specifically, FIG. 1 shows conventional touch panel display 100 including display panel 140 under polarizer 130 and overlay touch panel 120 disposed over polarizer 130. Top window glass 110 protects all underlying components. As is further shown in FIG. 1, touch sensor controller 180 (TSC) may facilitate touch sensing of touch panel 120 and communicates such touch sensing to an external device over flexible printed circuit board 165 (FPCB) using connector 175, for example. Similarly, display panel 120 may be controlled through FPCB 160 using connector 170, for example. Such connectors 170 and 175 may be used to interface with a controller for a handheld device such as a cell phone or tablet PC, for example. In some implementations, touch sensing may include reporting a position of an external object at a particular position on or above a mutual capacitive touch panel, for example.

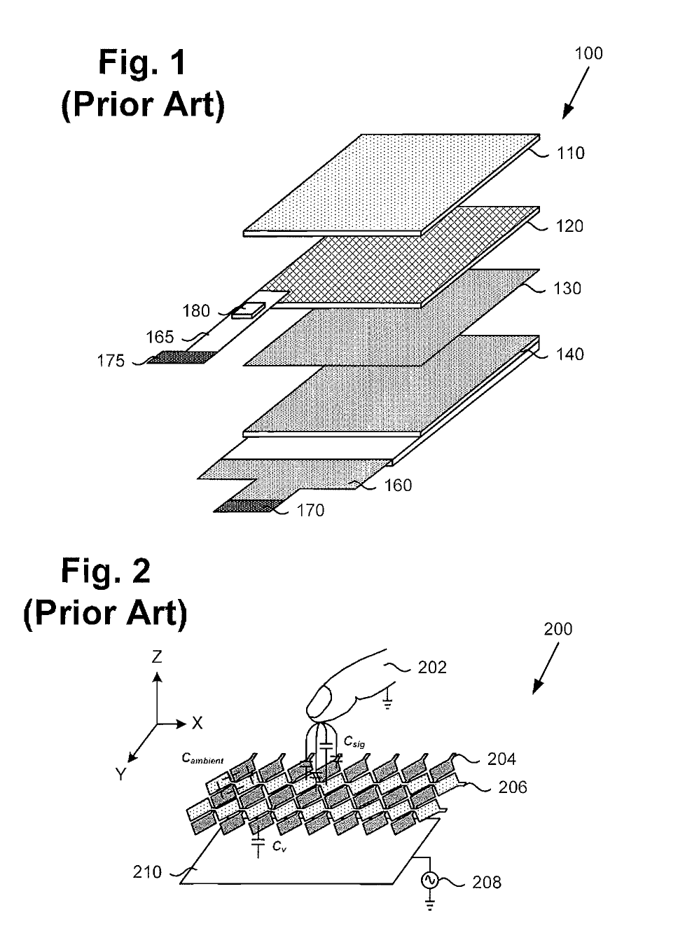

FIG. 2 presents a diagram showing the operation of a conventional array sensing circuit configured to sense a finger touch. Specifically, conventional mutual capacitive touch panel design 200 incorporates an array sensing circuit configured to sense a localized change in panel capacitance C_{sig} due to the presence of finger 202, for example. For instance, X sensing circuit 204 and Y sensing circuit 206 may include patterned layers of transparent conductive electrodes. Such conductive electrodes are capacitively coupled to each other, by capacitance C_{ambient}, for example, so as to allow touch sensing by sensing a change in capacitance between conductive electrodes caused by a nearby external object, depicted as the capacitance C_{sig}. With reference to FIG. 2, conventional touch panel designs may suffer from noise injection through, for example, capacitive coupling, denoted by Cᵥ, between the conductive electrodes of X and Y sensing circuits 204 and 206, respectively, and underlying display 210. Such noise is modeled by source 208.

In the absence of any nearby external object, conductive electrodes may be capacitively coupled to each other by a base mutual capacitance C_{ambient}. An important measure for mutual capacitive touch panel sensitivity is a change, ΔC, in mutual capacitance C_{ambient} between conductive electrodes of the panel due to a nearby external object. As shown in FIG. 2, ΔC may be the total change in the mutual capacitance seen by constituent conductive electrodes in the presence of an external object, such that ΔC=C_{sig}-C_{ambient}, for example. The ratio of ΔC to C_{ambient} may be used to characterize mutual capacitance touch panel sensitivity. To increase touch sense sensitivity, both ΔC and the ratio of ΔC to C_{ambient} should be increased. Because the ratio of ΔC to C_{ambient} should preferentially be as large as possible to ensure high touch panel sensitivity, C_{ambient} should also be kept as low as possible.

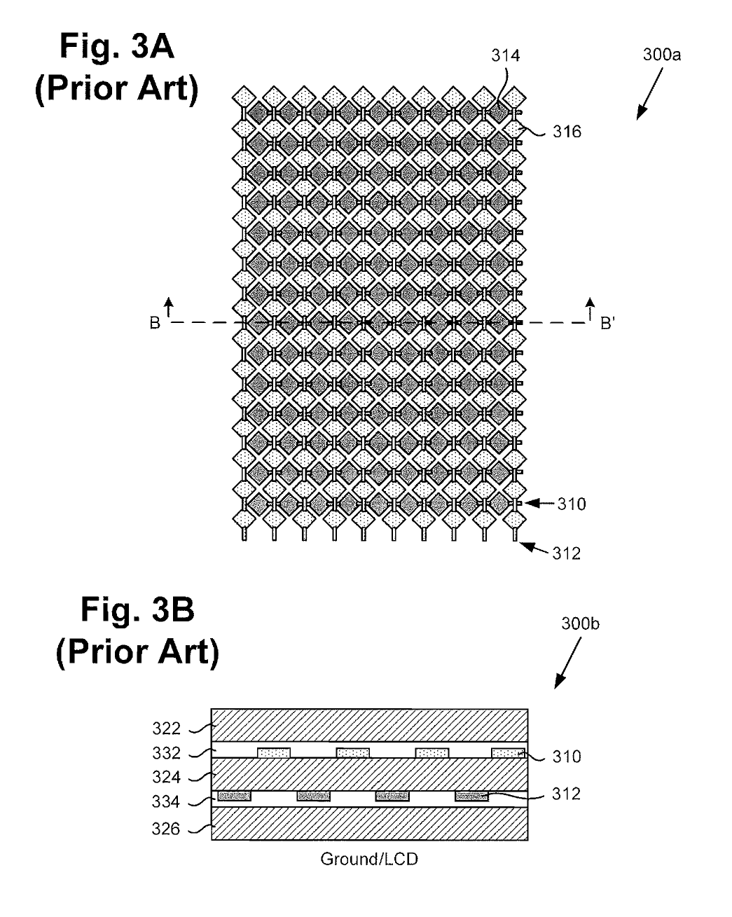

FIG. 3A presents a top view of an array of drive and sense electrodes of a conventional mutual capacitive touch panel display configured similarly to the sensing circuits shown in FIG. 2. As shown, one array of sensing circuits is designated as containing a plurality of drive lines 310. Each drive line 310 may include a plurality of individual drive electrodes 314, where drive signals are provided to drive electrodes 314 of each drive line 310 by, for example, a TSC such as TSC 180 shown in FIG. 1. In such an implementation, a separate array may be designated as containing a plurality of sense lines 312. Each sense line 312 may include a plurality of individual sense electrodes 316, where the drive signals provided to drive electrodes 314 couple capacitively to sense electrodes 316 and produce corresponding sense signals. Such sense signals may be used by a TSC to sense the presence of an object that produces a localized change in capacitance of a constituent panel. Drive lines 310 and sense lines 312, such as those shown in FIG. 3A, may include a transparent conductive material, for example, such as indium tin oxide (ITO).

FIG. 3B presents a cross-sectional view of an array of drive and sense electrodes of a conventional mutual capacitive touch panel display as in FIG. 3A. Specifically, FIG. 3B presents the cross section of FIG. 3A taken at the plane B-B′. The array of drive and sense electrodes are configured as a double-sided ITO (DITO) type stack-up mutual capacitive touch panel. As shown in FIG. 3B, mutual capacitive touch panel 300b may include cover-glass/film 322, middle-glass/film 324 and bottom glass/film 326 layers, each layer 0.7 mm thick, for example. Mutual capacitive touch panel 300b may further include top and bottom adhesive layers 332 and 334, respectively, configured to adhere adjacent glass/film layers with sense line and drive line ITO patterns situated there-between. Conventionally, all ITO layers may be 1 micron thick, and all adhesive layers may be 25 microns thick, for example.

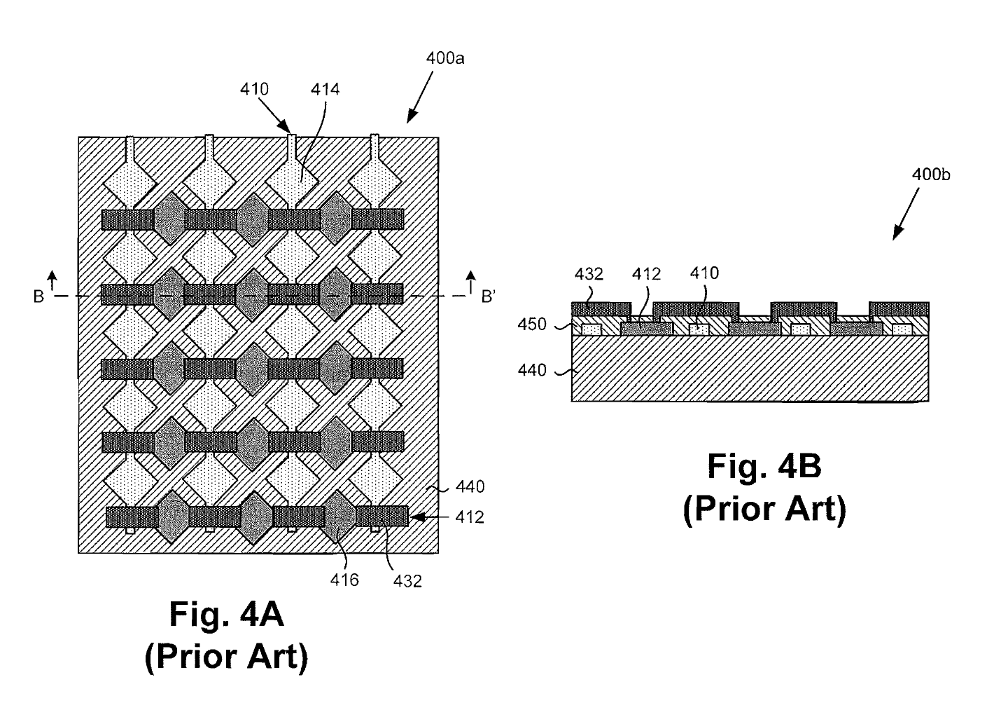

Moving to FIGS. 4A and 4B, FIGS. 4A and 4B present top and cross-sectional views, respectively, of a bridging type stack-up array of drive and sense electrodes used by a conventional mutual capacitive touch panel display. Specifically, FIG. 4B presents the cross section of FIG. 4A taken at the plane B-B′. Design 400a includes only a single cover glass with both the sense and drive electrodes patterned on one side. As can be seen in FIG. 4A, when both drive electrode 414 and source electrode 416 are patterned in the same plane on a single side of glass 440, either sense line pattern 412 or drive line pattern 410 requires an additional material layer in order to form a functional touch sensing array. For example, design 400a includes a patterned dielectric layer 450 over the ITO patterns, so that bridge pattern 432 may be formed over the patterned dielectric layer 450, forming an array of electrically connected drive electrodes as drive lines 410. In some implementations, a bridge pattern may include very narrow and thin segments of copper, for example. Such copper segments, shown as bridge patterns 432 in FIG. 4A, may be thin enough that they pass enough light produced from an underlying LCD, for example, to be substantially undetectable by a human eye. A thickness of approximately 20 microns may be suitable, for example. Although not shown in FIG. 4A or 4B, a further layer of optically transparent adhesive spacer may be formed between the bridge patterns and an underlying display. Design 400a may produce mutually capacitive touch panels approximately one-third the thickness of a similarly patterned DITO type stack-up touch panel, for example. However, the conventional designs of both FIGS. 3B and 4B rely on the spacing of the drive and sense electrodes from any underlying display panel to mitigate electromagnetic interference, which may be induced by the display panel.

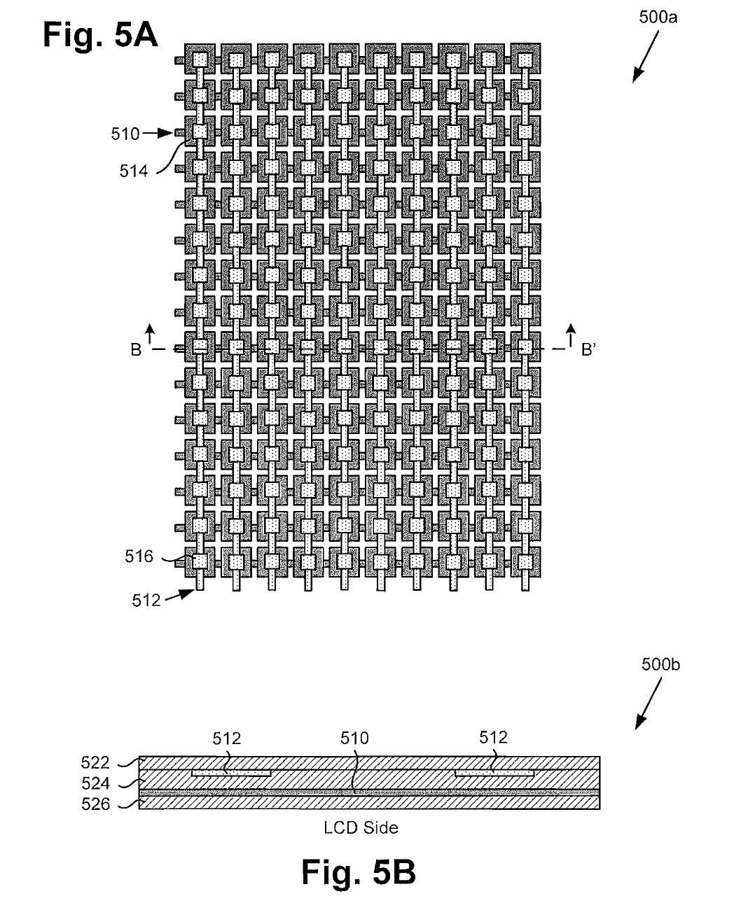

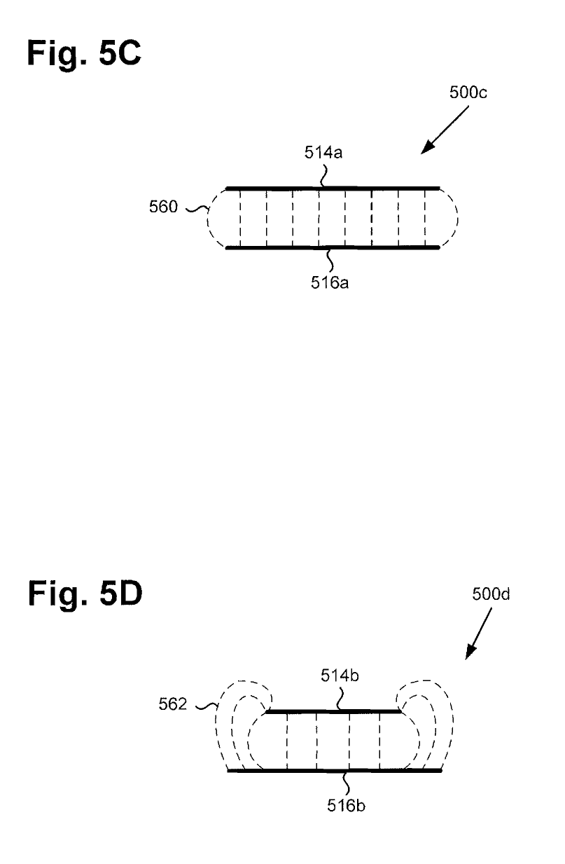

FIGS. 5A and 5B show exemplary touch panel electrode patterns configured to address the problems present in conventional designs, according to one implementation of the present application. FIG. 5A presents an exemplary top view of drive electrode and sense electrode arrays of a mutual capacitive touch panel display. Similarly, FIG. 5B presents a cross section of FIG. 5A taken at the plane B-B′. As can be seen from FIG. 5A, touch panel electrode patterns 500a includes sense line pattern 512 and drive line pattern 510, where drive line pattern 510 is configured to substantially shield sense line pattern 512 from electromagnetic noise generated by an underlying display. For example, as shown in FIG. 5A, almost the entirety of sense pattern 512 lies within the perimeter of drive pattern 510, where only a small gap between each sense electrode 516 is not shielded by a corresponding drive electrode 514. As such, the present implementation has significantly better noise immunity as compared to conventional designs.

FIG. 5B shows the cross sectional view of the touch panel electrode patterns of FIG. 5A, taken along the line B-B′. As shown in FIG. 5B, mutual capacitive touch panel 500b may include cover-glass/film 522, middle-glass/film 524 and bottom glass/film 526 layers, for example. Middle glass/film 524 may be a transparent dielectric layer which acts to insulate source lines 512 from drive lines 510. Because each drive electrode effectively shields an overlying sense electrode from electromagnetic noise generated by an underlying display, glass/film layers 522, 524 and 526 may be substantially thinner than in conventional designs, such as that shown in FIG. 3B for instance.

In addition, touch panel electrode patterns, such as patterns 500a, exhibit further advantages over conventional designs, which will now be explained with regard to FIGS. 5C and 5D. FIGS. 5C and 5D present exemplary cross-sectional views of electromagnetic field lines of sense and drive electrodes within a mutual capacitive touch panel display. As can be seen in FIG. 5C, a sense electrode 514a is substantially the same width as an underlying drive electrode 516a, and a majority of field lines are situated between the electrodes and are less able to interact with external objects for touch sensing. Further, fringing field lines 560 created by electrodes 514a and 516a, either largely fail to protrude out from between the two electrodes, or they protrude out from between the two electrodes in a symmetrical manner. Thus, any upward protrusion which is better able to interact with an external object for touch sensing, is at least partially counteracted by a symmetric downward protrusion that is more likely to be susceptible to electromagnetic noise produced by, for example, an underlying display panel.

FIG. 5D illustrates how sense and drive pattern pads may be configured to accentuate both touch sensing sensitivity and noise immunity. For example, as shown in FIG. 5D, sense electrode 514b may be configured to have a smaller width than an underlying aligned drive electrode 516b. Such an arrangement, where a perimeter of drive electrode 516b substantially encompasses a perimeter of sense electrode 514b, may produce fringing field lines 562 that extend out from sense electrode 514b to better interact with an external object for touch sensing. At the same time, the extended fringing field lines 562 may be shaped in order not to protrude beneath drive electrode 516b to prevent noise from an underlying display to degrade operation of a constituent touch panel. The result is essentially the shielding of the sense electrode from underlying electromagnetic noise.

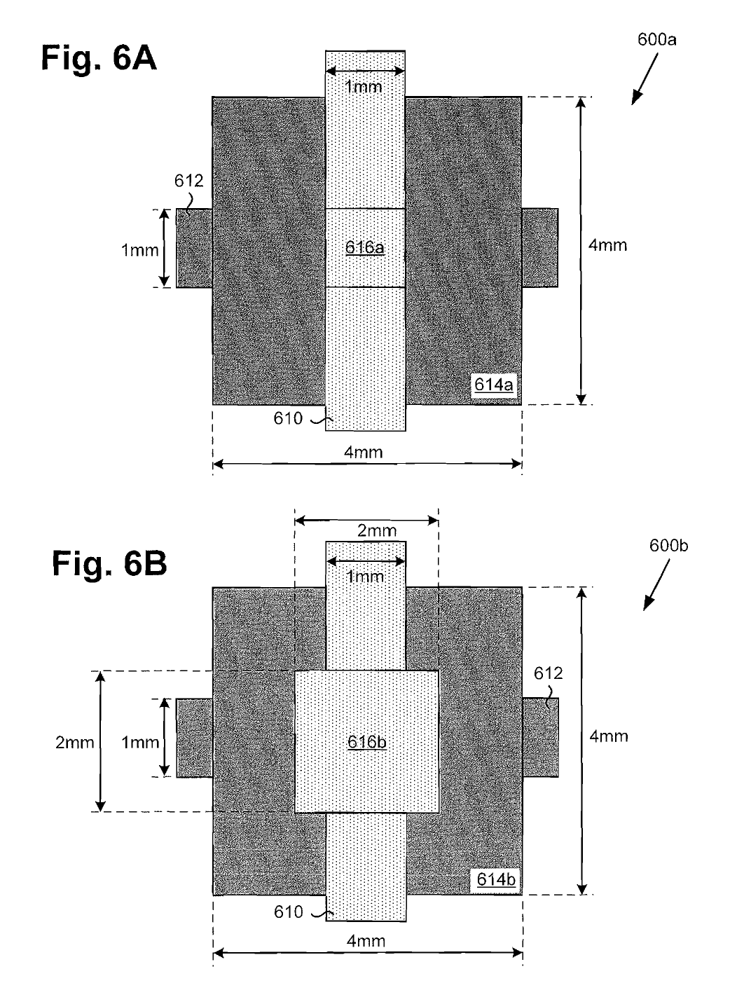

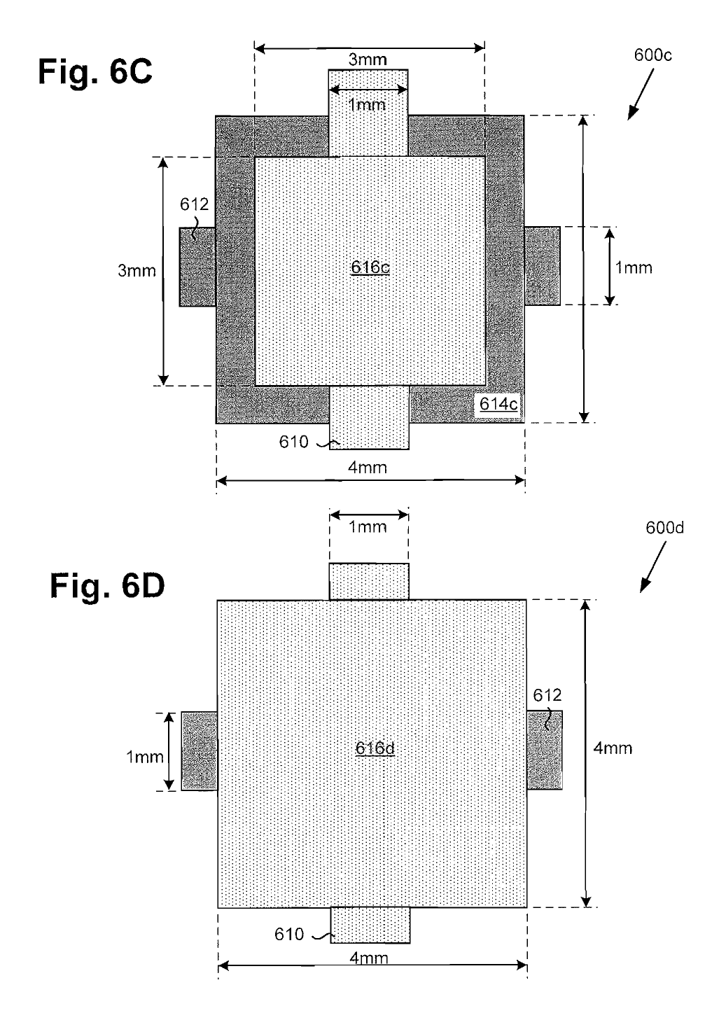

FIGS. 6A through 6D illustrate exemplary implementations of some concepts the present disclosure that balance resolution of sense electrodes and lines, for example, for various levels of noise immunity. Although each drive/sense electrode pair 600a, 600b, 600c and 600d is shown as having particular shapes and sizes measured in millimeters, it should be understood that these are not meant as limitations of the concepts. For example, in other implementations, the 1 mm square sense electrode 616 in FIG. 6A may instead be circular, rectangular, diamond shaped, or some other shape with an area following approximately the ratio of areas of sense/pad pair 600a. Furthermore, drive/sense electrode pair 600a in FIG. 6A may include different shapes from one another. In still another implementation, the 1 mm square sense pad in FIG. 6A may instead be some other shape with a perimeter following approximately the ratio of perimeters of drive/sense electrode pair 600a. Alternatively, the 1 mm square sense electrode 616 in FIG. 6A may be some other shape with an area following approximately the ratio of areas of drive/sense electrode pair 600a, but with a perimeter many times greater than a perimeter following approximately the ratio of perimeters of sense/pad pair 600a.

Continuing with FIG. 6A, FIG. 6A shows sense electrode 616a having a cross section of 1×1 millimeter disposed over drive electrode 614a having a cross section of 4×4 millimeters, for example. Sense electrode 616a is connected to adjacent sense electrodes (not shown) via conductive sense line 610. Similarly, drive electrode 614a is connected to adjacent drive electrodes (not shown) via conductive drive line 612. The design shown by FIG. 6A can provide the characteristics and benefits previously described with respect to the structure of FIG. 5D.

FIG. 6B shows a sense/drive electrode pair 600b substantially as disclosed in FIG. 6A with the exception that sense electrode 616b has a cross section of 2×2 millimeters, for example. Similarly, FIG. 6C shows a sense/drive electrode pair 600c substantially as disclosed in FIGS. 6A and 6B with the exception that sense electrode 616c has a cross section of 3×3 millimeters, for example. Finally, FIG. 6D shows a sense/drive electrode pair 600d wherein both sense electrode 616d and drive electrode 614d (not shown under 616d) have a cross section of 4×4 millimeters. Though the design illustrated in FIG. 6D is similar to that disclosed previously regarding FIG. 5C, the design of FIG. 6D may still enjoy the performance benefits previously described with respect to the structures disclosed in FIGS. 5D and 6A through 6C.

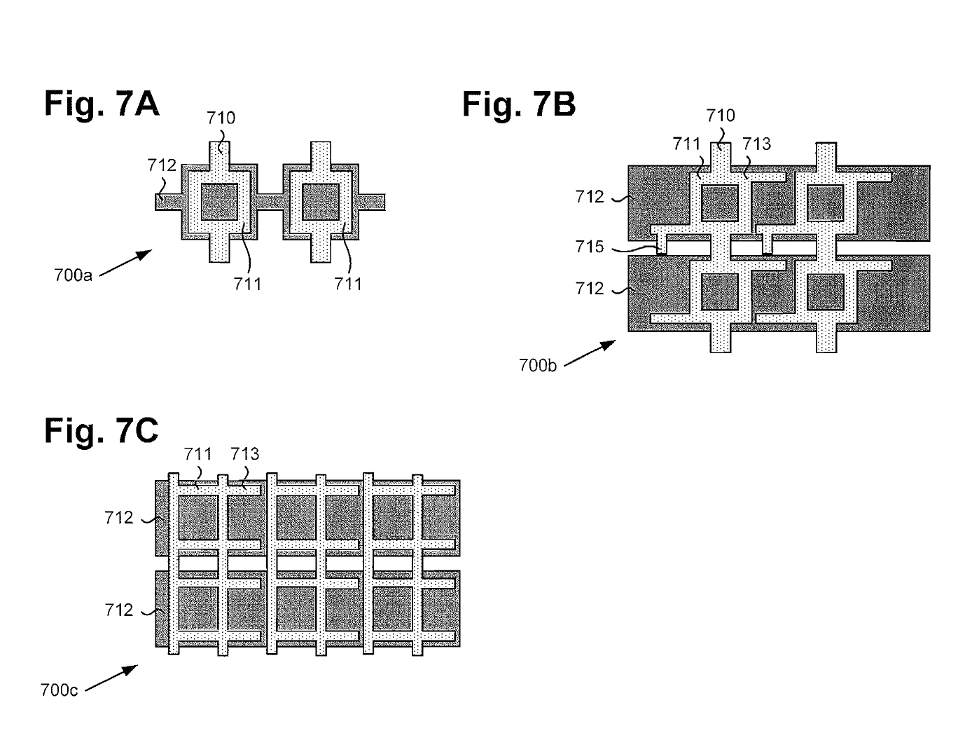

FIGS. 7A-7C illustrate still other exemplary implementations of some concepts the present disclosure that preserve noise immunity while maximizing the perimeter of the sense electrodes through varied structural designs. Maximizing the perimeter of the sense electrodes serves to increase the number of outward extending fringe field lines, thus improving overall touch sensing sensitivity. In addition, reducing the area of the sense electrodes while maximizing their perimeter keeps base capacitance C_{ambient} of the drive/sense pairs low, thus increasing the ΔC/C_{ambient} ratio and the touch sense sensitivity of the design. FIG. 7A shows an exemplary implementation where the sense line 710 includes a loop 711 instead of a simple square-shaped sense electrode. The drive pattern 712 further includes drive electrodes having perimeters that substantially encompass the perimeters of overlying sense electrode loops 711. Thus, the loop design allows an increase in the sense electrode perimeter to area ratio.

FIG. 7B shows an exemplary implementation where sense line 710 includes conductive loop 711, conductive finger 713 extending laterally away from conductive loop 711, and finger 715 extending laterally away from conductive loop 711 on a side of conductive loop 711 opposite from first conductive finger 713. Furthermore, drive line 712 may include a relatively homogenous strip rather than a series of distinct drive electrodes. As can be seen in FIG. 7B, neither finger 713 nor finger 715 directly electrically contact an adjacent sense electrode. Such an arrangement serves to increase a perimeter to area ratio of the sense electrode while maintaining high spatial resolution and reduced noise immunity.

FIG. 7C shows an exemplary arrangement of sense and drive electrodes particularly well suited to provide high ΔC and a high ratio of ΔC to C_{ambient} without substantially sacrificing spatial resolution. As shown in FIG. 7C, the sense pattern may include a series of loops 711 with corresponding fingers 713, such that each loop 711 and two corresponding fingers 713 are completely shielded by an underlying drive line 712.

Sense electrode loops may be configured to increase ΔC when an external object is nearby without increasing C_{ambient}, thereby increasing touch sense sensitivity as described above regarding FIG. 2. Similarly, in some implementations, fingers in a sense pattern may be configured to shape fringing field lines to increase ΔC, for example, as explained above. In addition, or in the alternative, fingers in a sense pattern, may be configured to provide increased spatial resolution that may otherwise be lost when arranging a sense pattern to be shielded by an underlying drive pattern. Increases in spatial resolution can be realized in this manner by designing the locations of fingers and loops such that a perimeter edge of a finger or loop is near any point across the active surface of the touch panel.

One advantage of encompassing substantially all of a sense pattern perimeter within an underlying drive pattern to shield the overlying sense electrode is the ability to reduce the overall thickness of a display/touch panel combination. Increased noise immunity allows a touch panel to be placed in closer proximity to an underlying display without suffering detrimental effects due to electromagnetic noise. However, one drawback to encompassing substantially all of a sense pattern perimeter within an underlying drive pattern is that such designs may lead to sense electrodes spaced far enough from each other than spatial resolution is undesirably low. This is particularly true with respect to fine pitch conductive stylus points, which may be approximately 1 mm in diameter used to facilitate certain language scripts, for example. While any of the above patterns may be shrunk down in size to correspondingly increase spatial resolution, doing so may increase the required number of panel input/output (I/O) connections in a particular drive and sense pattern. However, as the number of panel I/O connections increases, the complexity and cost of both the mutual capacitance touch panel and a TSC used to control the panel also increases.

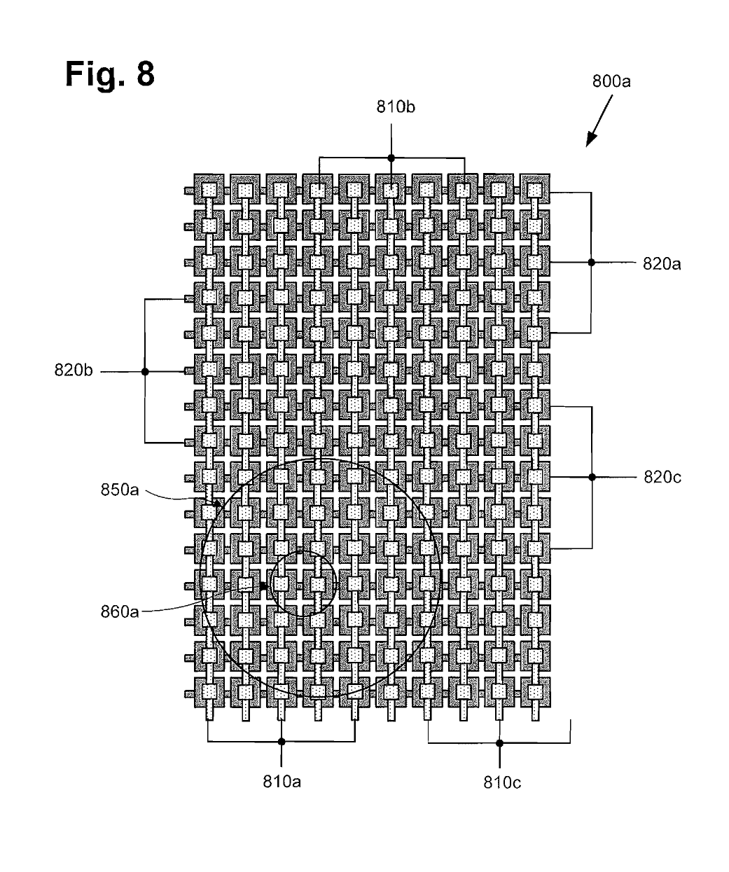

FIG. 8 shows one exemplary implementation of some concepts the present disclosure that addresses this undesirable increase in complexity and cost. FIG. 8 shows interdigitated electrode pattern 800a including sense electrode groups 810a, 810b, 810c and drive electrode groups 820a, 820b, and 820c. Also illustrated in FIG. 8 are rough pitch sense area 850a and fine pitch sense area 860a. As illustrated in FIG. 8, each sense electrode group is interdigitated with its nearest neighboring sense electrode groups. For example, sense electrode group 820a is interdigitated with sense electrode group 810a and 830a, such that even fine pitch sense area 860a, which may correspond to a conductive stylus with a 1 mm point for example, covers at least one electrode of two adjacent interdigitated sense electrode groups. In this figure, fine pitch sense area 860a covers electrodes in both sense electrode groups 810a and 820a. Furthermore, each sense electrode group in FIG. 8 includes multiple sense lines. Likewise, interdigitated electrode pattern 800a may also provide that each drive electrode group includes multiple drive lines. Thus, a total number of required panel I/O connections is reduced from a total number of sense lines and drive lines by a factor proportional to the number of individual sense or drive lines in each sense electrode group or drive electrode group, respectively.

As such, a corresponding TSC may be configured to use sense signals from each sense electrode group and/or each drive group to sense a presence of any object that produces a localized change in capacitance of a constituent panel. In some implementations, a corresponding TSC may be configured to interpolate sense signals from each sense electrode group and drive signals from each drive electrode group to reach a spatial resolution corresponding to the spatial resolution of each sense electrode, for example. As such, spatial resolution may be increased without incurring a cost or complexity associated with increasing panel I/O connections. By providing increased spatial resolution without a concomitant increase in panel I/O connections, implementations of some concepts the present disclosure may also reduce a required exclusion region of a touch panel, for example, dedicated to routing panel I/O connections to a TSC, for instance. As such, implementations of some concepts the present disclosure may be configured to reliably sense touches closer to an edge of a touch screen, for example.

Although FIG. 8 shows sense and drive electrode groups formed into groups of three sense and drive lines that in turn include diamond shaped sense and drive electrodes, none of these specific characteristics should be construed as limitations of the concepts. In other implementations, each electrode group may include more or less than three sense or drive lines, and may additionally include a changing pattern of groups of electrodes. For instance, in one implementation, an interdigitated array may include drive electrode groups alternating between 2 and 3 drive lines in each successive drive electrode group. Further, in other implementations, only sense or drive lines may be formed into electrode groups.

In addition, some implementations of the present disclosure may combine the noise immunity and touch sense sensitivity benefits of, for example, the implementations illustrated by FIGS. 5A through 7C, with the increased spatial resolution provided by interdigitated electrode patterns shown in FIG. 8. Moreover, each implementation may incorporate any compatible stack-up configuration for producing a particular drive/sense pattern, such as the DITO type stack-up configuration as shown in FIGS. 3A and 3B, the bridging type stack-up configuration as shown in FIGS. 5A and 5B, or any compatible combination of stack-up configurations, for example. Thus, various implementations according to the present disclosure may be fabricated so as to cost effectively increase electromagnetic noise immunity, increase fine pitch conductive stylus support, increase touch sensing sensitivity, and produce overall thinner touch panels and touch panel/display combinations.

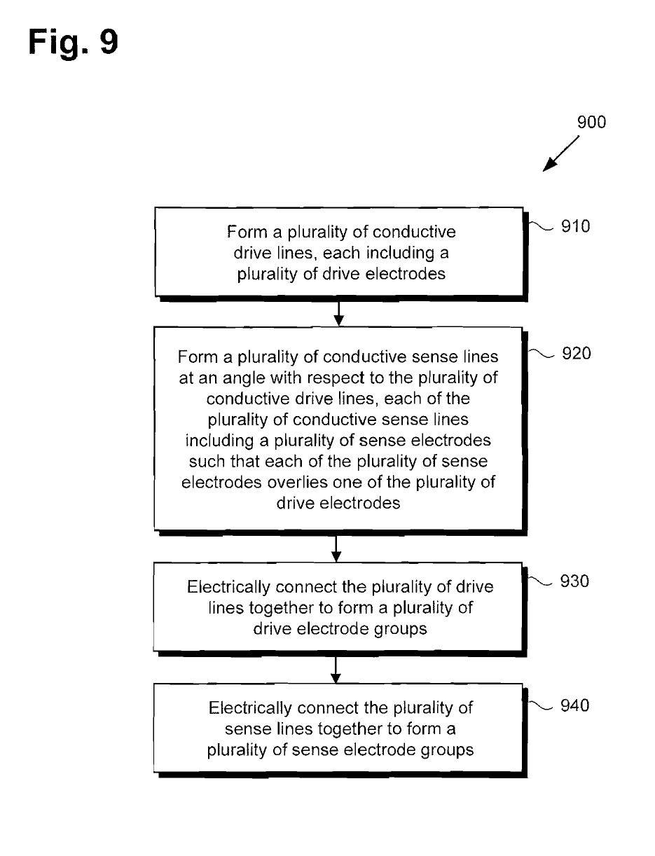

Moving to FIG. 9, an exemplary method for providing improved noise immunity and spatial resolution in a touch panel display is described. FIG. 9 presents an exemplary flowchart implementing such a method.

Action 910 of flowchart 900 includes forming a plurality of conductive drive lines, each including a plurality of drive electrodes. With reference to FIG. 5A, these conductive drive lines may correspond to drive lines 510, for example.

Continuing with flow chart 900, action 920 includes forming a plurality of conductive sense lines at an angle with respect to the plurality of conductive drive lines. Each of the plurality of conductive sense lines includes a plurality of sense electrodes such that each of the plurality of sense electrodes overlies one of the plurality of drive electrodes. With reference to FIG. 5A, these conductive sense lines may correspond to sense lines 512. As disclosed by FIG. 5A, each of sense lines 512 includes a plurality of sense electrodes 516. Moreover, each of sense electrodes 516 overlies a corresponding drive electrode 514, for example. Of particular importance, FIG. 5A illustrates how the perimeter of each of drive electrodes 514 encompasses the perimeter of a corresponding sense electrode 516, for example. This arrangement results in each sense electrode 516 being substantially shielded from electromagnetic noise, which may be induced by underlying circuitry or a display panel, for instance.

Action 930 of flowchart 900 includes electrically connecting the plurality of drive lines together to form a plurality of drive electrodes. With reference to FIG. 8, multiple drive lines are electrically connected together to form drive electrode groups 820a, 8206 and 820c, for example. FIG. 8 further illustrates how each of drive electrode groups 820a-820c may be interdigitated with one another such that each of the drive lines from each of the drive electrode groups is disposed adjacent to a drive line from another drive electrode group. Furthermore, each drive electrode group may include more or less than three drive lines, or may include a changing pattern of connected drive lines, for example. For instance, in one implementation, an interdigitated drive electrode group pattern may include drive electrode groups alternating between 2 and 3 drive lines in each successive drive electrode group.

Continuing with flowchart 900, action 940 includes electrically connecting the plurality of sense lines together to form a plurality of sense electrodes. With reference to FIG. 8, multiple sense lines are electrically connected together to form sense electrode groups 810a, 810b and 810c, for example. FIG. 8 further illustrates how each of sense electrode groups 810a-810c may be interdigitated with one another such that each of the sense lines from each of the sense electrode groups is disposed adjacent to a sense line from another sense electrode group. Furthermore, each sense electrode group may include more or less than three sense lines, or may include a changing pattern of connected sense lines, for example. For instance, in one implementation, an interdigitated sense electrode group pattern may include sense electrode groups alternating between 2 and 3 sense lines in each successive sense electrode group.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the spirit and the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A touch panel comprising:
a drive line having a plurality of drive electrodes; and
a sense line arranged at an angle with respect to the drive line and the sense line having a plurality of sense electrodes, wherein each of the plurality of sense electrodes overlies one of the plurality of drive electrodes;
wherein a perimeter of each of the plurality of drive electrodes encompasses a perimeter of at least one of the plurality of sense electrodes.

2. The touch panel of claim 1, wherein a shape of the plurality of sense electrodes is selected from the group consisting of a circle, a square, a rectangle and a diamond.

3. The touch panel of claim 1, wherein a shape of the plurality of drive electrodes is selected from the group consisting of a circle, a square, a rectangle and a diamond.

4. The touch panel of claim 1 further comprising a transparent dielectric disposed between the drive line and the sense line.

5. The touch panel of claim 1, wherein each of the plurality of sense electrodes comprises one or more conductive loops.

6. The touch panel of claim 5, wherein each of the plurality of sense electrodes further comprises one or more conductive fingers extending away from the one or more conductive loops.

7. The touch panel of claim 1, wherein the perimeter of each of the plurality of drive electrodes encompassing the perimeter of one of the plurality of sense electrodes enables a plurality of fringe field lines to extend above and away from each of the plurality of sense electrodes.

8. The touch panel of claim 1 further comprising:
a plurality of drive electrode groups, each comprising a plurality of drive lines electrically connected together, the drive line included in one of the plurality of drive electrode groups; and
a plurality of sense electrode groups, each comprising a plurality of sense lines electrically connected together, the sense line included in one of the plurality of sense electrode groups.

9. The touch panel of claim 8, wherein the plurality of drive electrode groups are interdigitated such that each of the plurality of drive lines from each of the plurality of drive electrode groups is disposed adjacent to one of the plurality of drive lines from another one of the plurality of drive electrode groups.

10. The touch panel of claim 8, wherein the plurality of sense electrode groups are interdigitated such that each of the plurality of sense lines from each of the plurality of sense electrode groups is disposed adjacent to one of the plurality of sense lines from another one of the plurality of sense electrode groups.

11. A touch panel comprising:
a plurality of drive electrode groups, each comprising a plurality of drive lines electrically connected together; and
a plurality of sense electrode groups, each comprising a plurality of sense lines electrically connected together and arranged at an angle with respect to the plurality of drive lines;
wherein the plurality of drive electrode groups are interdigitated such that each of the plurality of drive lines from each of the plurality of drive electrode groups is disposed adjacent to one of the plurality of drive lines from another one of the plurality of drive electrode groups.

12. The touch panel of claim 11, wherein the plurality of sense electrode groups are interdigitated such that each of the plurality of sense lines from each of the plurality of sense electrode groups is disposed adjacent to one of the plurality of sense lines from another one of the plurality of sense electrode groups.

13. The touch panel of claim 11, wherein each one of the plurality of drive lines comprises a plurality of drive electrodes and each of the plurality of sense lines comprises a plurality of sense electrodes arranged such that each of the plurality of sense electrodes overlies one of the plurality of drive electrodes.

14. A method comprising:
providing a plurality of conductive drive lines, each including a plurality of drive electrodes; and
providing a plurality of conductive sense lines at an angle with respect to the plurality of conductive drive lines, each of the plurality of conductive sense lines including a plurality of sense electrodes such that each of the plurality of sense electrodes overlies one of the plurality of drive electrodes;
wherein a perimeter of each of the plurality of drive electrodes encompasses a perimeter of one of the plurality of sense electrodes to shield the plurality of sense electrodes from electromagnetic noise.

15. The method of claim 14, wherein a shape of the plurality of sense electrodes and a shape of the plurality of drive electrodes are selected from the group consisting of a circle, a square, a rectangle and a diamond.

16. The method of claim 14, wherein each of the plurality of sense electrodes are formed to comprise one or more conductive loops such that a plurality of fringe field lines extend above and away from each of the plurality of sense electrodes.

17. The method of claim 16, wherein each of the plurality of sense electrodes are formed to further comprise one or more conductive fingers extending away from the one or more conductive loops.

18. The method of claim 14, further comprising:
electrically connecting the plurality of drive lines together to form a plurality of drive electrode groups; and
electrically connecting the plurality of sense lines together to form a plurality of sense electrode groups.

19. The method of claim 18, wherein the plurality of sense electrode groups are interdigitated such that each of the plurality of sense lines from each of the plurality of sense electrode groups is disposed adjacent to one of the plurality of sense lines from another one of the plurality of sense electrode groups.

20. The method of claim 18, wherein the plurality of drive electrode groups are interdigitated such that each of the plurality of drive lines from each of the plurality of drive electrode groups is disposed adjacent to one of the plurality of drive lines from another one of the plurality of drive electrode groups.
